(19) United States
(12) Patent Application Publication
(10) Pub. No.: US 2005/0105852 A1
(43) Pub. Date: May 19, 2005

(54) Vertical device geometry the incorporation of Bragg gratings into photonic integrated circuits

(76) Inventor: Arkady Bablumyan, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/954,978

(22) Filed: Sep. 29, 2004

Related U.S. Application Data
(60) Provisional application No. 60/507,422, filed on Sep. 29, 2003.

(51) Int. Cl. G02B 6/34

(52) U.S. Cl. 385/37

(57) ABSTRACT

A method for producing photonic integrated circuits (PICs) containing Bragg gratings and other structures. The method uses a vertical geometry with multiple waveguide layers and provides for processing through the bottom of the device.

### RELATED APPLICATION

The present application claims the benefit. of priority to U.S. Provisional Patent Application Ser. No. 60/507,422, filed Sep. 29, 2003, and currently co-pending.

### PROBLEM & BACKGROUND

Comp-Optics has developed a sol-gel based process for creating PICs. This process allows waveguides to be created by exposing the sol-gel waveguide layer to ultraviolet (UV) illumination. The index of the exposed material is increased leading to the creation of the waveguide. As the sol-gel layer being written into is tacky, it is not possible to place a mask in direct contact with this layer. Instead, waveguides are created via a mask projection system or by drawing a laser beam on the PIC to create waveguides.

Many structures can benefit from the ability to place Bragg gratings inside of waveguides. For example, Comp-Optics has developed a unique optical add/drop multiplexer that utilizes a waveguide Bragg grating, see separate disclosure. Bragg grating can be produced by projecting a laser beam through an interference mask and having the resultant fringe pattern create an intensity profile along a waveguide. The intensity profile will cause the index of the waveguide layer to vary in relation to the intensity. Unfortunately, it is difficult to control the width of the resultant grating. One solution is to have a mask block unwanted illumination. This is difficult with CompOptics process as one can not place the mask in direct contact with the waveguide layer.

This disclosure describes a method of placing Bragg gratings and waveguides in PICs that is simple and fast.

### INVENTION DESCRIPTION

The invention allows Bragg gratings and waveguides to be created. The processing steps are as follows:
Place a chromium (or other opaque substance) layer against the glass substrate.
Etch the waveguide or Bragg grating position pattern in the chromium layer.
Place a thin (1 to 2 micron) sol-gel cladding layer over the chromium layer. If the waveguide layer lies directly on top of the chromium layer losses will be higher than desired. Fix the layer
Place a waveguide/Bragg layer (typically 6 microns) on top of the cladding layer.
Create the waveguides or Bragg gratings in the waveguide layer as follows:
For waveguides project UV illumination (full substrate projection or laser drawn) through the backside of the substrate. The mask will block light from nonwaveguide areas.
For Bragg gratings project UV laser illumination through the desired interference mask then through the backside of the substrate. The chromium mask will block light from non-Bragg grating areas.
Fix the layer.
Place a thin cladding layer on top of the waveguide/Bragg layer. The thickness is typically 1 to 2 microns and determined to achieve the desired coupling between waveguide/Bragg layer structures and upper waveguide layer structures. Fix the layer.
Place an upper waveguide layer (typically 6 microns) on top of the cladding layer.
Create waveguides in this layer via laser drawing or mask projection. For this layer illumination is from the top side of the structure.
Fix the layer.
Place an upper cladding layer (typically 6 microns) on top of the upper waveguide layer. Fix the layer.

The structure described above has two waveguide layers. Note that using the same process additional waveguide layers can be created. The chromium mask allows Bragg gratings to be created in the lower layer that will allow evanescent coupling to waveguides in the upper waveguide layer. The figure below shows the structure with a Bragg grating in the lower layer. The structure is shown with the glass substrate at the top. The yellow layer is the chromium mask. Red layers are cladding (note that the upper cladding layer is not shown.)

1. An optical device, comprising:
a first waveguide layer
a second waveguide layer adjacent said first waveguide layer; and
a bragg grating formed in said second waveguide layer to provide evanescent coupling between said first waveguide layer and said second waveguide layer.
